(19) United States
(12) Patent Application Publication
(10) Pub. No.: US 2010/0236736 A1
(43) Pub. Date: Sep. 23, 2010

(54) FINE-PARTICLED POLYMER DISPERSIONS CONTAINING STARCH

(75) Inventors: Andreas Brockmeyer, Bickenbach (DE); Hildegard Stein, Mannheim (DE); Roland Ettl, Ketsch (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaft, Ludwigshafen (DE)

(21) Appl. No.: 11/994,213

(22) PCT Filed: Jun. 23, 2006
(86) PCT No.: PCT/EP06/63503

§ 371 Date: Aug. 14, 2008

(30) Foreign Application Priority Data
Jun. 29, 2005 (DE) 102005030789.2

(51) Int. Cl. D21H 17/28; C08L 3/02

(52) U.S. Cl. 162/168.2; 524/734; 162/168.1

(57) ABSTRACT

Finely divided, starch-containing polymer dispersions which are obtainable by free radical emulsion copolymerization of
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer
   and
(e) from 15 to 40% by weight of a degradable starch which has a molar mass M_{w} of from 1000 to 65 000
   the sum (a)+(b)+(c)+(d)+(e) being 100% and being based on the total solids content, in the presence of redox initiators and at least 0.01% by weight, based on the monomers used, of at least one polymerization regulator, processes for the preparation of the finely divided, starch-containing polymer dispersions by emulsion polymerization of the monomers (a), (b), (c) and (d) with redox initiators in the presence of (e) degraded starch and at least 0.01% by weight, based on the monomers used, of at least one polymerization regulator, and use of the finely divided, starch-containing polymer dispersions as sizes for paper, board and cardboard.

The invention relates to finely divided, starch-containing polymer dispersions which are obtainable by emulsion polymerization of ethylenically unsaturated monomers in the presence of at least one redox initiator and starch, processes for the preparation of the dispersions and their use as sizes for paper.

EP-B-0 276 770 and EP-B-0 257 412 disclose sizes based on finely divided, aqueous dispersions which are obtainable by copolymerization of ethylenically unsaturated monomers, such as acrylonitrile and (meth)acrylates and, if appropriate, up to 10% by weight of other monomers, such as styrene, by an emulsion polymerization method in the presence of initiators comprising peroxide groups, in particular of redox initiators, and degraded starch.

EP-A-0 307 812 describes, as sizes, inter alia also finely divided, aqueous, cationic polymer dispersions which are obtainable by emulsion copolymerization of
(i) acrylonitrile, methacrylonitrile, methyl methacrylate and/or styrene,
(ii) at least one acrylate or methacrylate of in each case monohydric, saturated, C₃-C₈-alcohols, vinyl acetate, vinyl propionate and/or 1,3-butadiene and, if appropriate,
(iii) other ethylenically unsaturated monomers in an aqueous solution of a degraded cationic starch in the presence of a redox initiator.

EP-A-0 536 597 discloses aqueous polymer dispersions which are obtainable by free radical emulsion copolymerization of unsaturated monomers in the presence of a starch degradation product. The starch degradation product forms as a result of hydrolysis in the aqueous phase and, at room temperature, has complete solubility in water at a weight average molecular weight M_{w}, of from 2500 to 25 000. Preferably used monomer mixtures are mixtures of styrene and (meth)acrylates of monohydric, saturated C₁-C₁₂-alcohols in combination with up to 10% by weight of acrylic acid and/or methacrylic acid. The dispersions are used as binders, adhesives or sizes for fibers or for the production of coatings.

EP-B-1 056 783 likewise discloses aqueous, finely divided polymer dispersions which are used for the surface sizing of paper, board and cardboard. The dispersions are obtainable by free radical emulsion polymerization of ethylenically unsaturated monomers in the presence of degraded starch having a number average molecular weight Mₙ of from 500 to 10 000. The monomer mixtures consist of (i) at least one optionally substituted styrene, (ii) at least one C₁-C₄-(meth)acrylate and (iii) if appropriate up to 10% by weight of other ethylenically unsaturated monomers. The polymerization is effected in the presence of a graft-linking, water-soluble redox system.

WO-A-00/23479 likewise discloses sizes which are obtainable by free radical emulsion copolymerization of a monomer mixture (A) comprising, for example, (i) at least one optionally substituted styrene, (ii) if appropriate at least one C₄-C₁₂-alkyl(meth)acrylate and (iii) at least one monomer from the group consisting of methyl acrylate, ethyl acrylate and propyl acrylate in the presence of (B) starch having an average molecular weight of 1000 or more, the weight ratio of (A):(B) being from 0.6:1 to 1.7:1; the size is free of emulsifiers or surface-active agents having a molecular weight of less than 1000 and comprises virtually no monomers which have acid groups and are incorporated in the form of polymerized units. Cationic starch, in particular oxidized cationic corn starch, is preferred as component (B) of the size, and the component (A) preferably consists of a mixture of styrene, n-butyl acrylate and methyl acrylate.

EP-B-1 165 642 discloses a further polymer dispersion and a process for its preparation, a monomer mixture which comprises at least one vinyl monomer being polymerized in an aqueous solution of a starch which has a degree of substitution (DS), based on the cationic or anionic substituents, of from 0.01 to 1 and, in cationized and/or anionized form, has a limiting viscosity of >1.0 dl/g. The starch used in the polymerization is either not degraded or only slightly oxidized but on no account enzymatically degraded. The resulting polymer has a film formation temperature of −50 to +200° C. It is composed, for example, of acrylates and styrene and, if appropriate, acrylonitrile. The polymer dispersions thus preparable are used as sizes for paper.

According to the process disclosed in WO-A-02/14393, sizes and coating materials for paper are prepared by free radical emulsion polymerization of a monomer mixture comprising (i) at least one (meth)acrylate of monohydric, saturated C₃-C₈-alcohols and (ii) one or more further ethylenically unsaturated monomers in the presence of starch and/or of a starch derivative, monomers and initiators being fed continuously to an aqueous starch solution, and the initiator being metered in two portions under specially defined conditions.

Also known are starch-based polymers which can be prepared by polymerization of (i) from 35 to 65% by weight of an ethylenically unsaturated monomer which is free of carboxyl groups, (ii) from 35 to 65% by weight of an ethylenically unsaturated mono- or dicarboxylic acid or the salts thereof and (iii) from 0 to 15% by weight of another ethylenically unsaturated monomer in an aqueous medium in the presence of starch, cf. WO-A-2004/078807. The starch used may be natural starch, dextrin and starch derivatives. The polymers formed are water-soluble. They are used as sizes for paper, board and cardboard.

It is the object of the invention to provide further starch-containing polymer dispersions which have improved performance characteristics compared with the known, comparable polymer dispersions, for example an improved sizing effect on alum-containing papers.

The object is achieved, according to the invention, by finely divided, starch-containing polymer dispersions which are obtainable by free radical emulsion copolymerization of ethylenically unsaturated monomers in the presence of at least one redox initiator and starch, if
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer
   are used as ethylenically unsaturated monomers and
(e) from 15 to 40% by weight of at least one degradable starch which has a molar mass M_{w}, of from 1000 to 65 000
   are used as starch,
   the sum (a)+(b)+(c)+(d)+(e) being 100% and being based on the total solids content, and if the polymerization is carried out in the presence of at least 0.01% by weight, based on the monomers used, of at least one polymerization regulator.

Preferred polymer dispersions are those which are prepared using
(a) from 30 to 40% by weight of at least one optionally substituted styrene, methyl methacrylate, acrylonitrile and/or methacrylonitrile,
(b) from 15 to 25% by weight of at least one C₁-C₄-alkyl acrylate and/or one C₂-C₄-alkyl methacrylate,
(c) from 15 to 25% by weight of at least one C₅-C₁₈-alkyl acrylate and/or one C₅-C₁₈-alkyl methacrylate and
(d) from 0 to 10% by weight of at least one other ethylenically unsaturated copolymerizable monomer,
   as ethylenically unsaturated monomers and
(d) from 25 to 35% by weight of at least one degraded starch which has a molar mass M_{w}, of from 2500 to 35 000, as starch,
   the sum (a)+(b)+(c)+(d)+(e) being 100% and being based on the total solids content.

The finely divided, starch-containing polymer dispersions are preferably obtainable by using at least one organic compound which comprises sulfur in bound form as a regulator in the polymerization of the monomers.

Particularly preferred polymer dispersions are those which are prepared using
(a) a monomer from the group consisting of styrene, methyl methacrylate, acrylonitrile and/or methacrylonitrile,
(b) n-butyl acrylate, isobutyl acrylate, sec-butyl acrylate and/or tert-butyl acrylate,
(c) 2-ethylhexyl acrylate and/or 2-ethylhexyl methacrylate and
(d) at least one monomer from the group consisting of vinyl acetate, vinyl propionate, hydroxyethyl acrylate, hydroxyethyl methacrylate, N-vinylformamide, acrylamide, methacrylamide, N-vinylpyrrolidone, N-vinylcaprolactam, N-vinylimidazole, acrylic acid, methacrylic acid, acrylamidomethylpropanesulfonic acid, vinylsulfonic acid, styrenesulfonic acid and salts of the monomers comprising acid groups
   as ethylenically unsaturated monomers and tert-dodecyl mercaptan as the regulator.

The regulators are used, for example, in an amount of from 0.01 to 10% by weight, preferably from 0.05 to 5.0% by weight, based in each case on the monomers.

The invention also relates to a process for the preparation of the finely divided, starch-containing polymer dispersions,
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer
   and
(e) from 15 to 40% by weight of at least one degraded starch which has a molar mass M_{w} of from 1000 to 65 000, the sum (a)+(b)+(c)+(d)+(e) being 100% and being based on the total solids content, being polymerized in the presence of a redox initiator and of at least 0.01% by weight, based on the monomers used, of at least one polymerization regulator.

Suitable monomers of group (a) are optionally substituted styrenes, methyl methacrylate, acrylonitrile and/or methacrylonitrile. Preferred monomers of this group are styrene and methyl methacrylate. Optionally substituted styrenes are to be understood as meaning, for example, α-methylstyrene, styrenes halogenated on the ring, such as chlorostyrene, or C₁- to C₄-substituted styrenes, such as vinyltoluene. The monomers of group (a) are present in an amount of, for example, from 25 to 50, preferably from 30 to 40, % by weight in the reaction mixture comprising the components (a), (b), (c), (d) and (e).

C₁-C₄-Alkyl acrylates and/or C₂-C₄-alkyl methacrylates are used as monomers of component (b). The suitable esters of acrylic acid and of methacrylic acid are derived from monohydric C₂- to C₄-alcohols. Another suitable acrylate is methyl acrylate. Examples of monomers of this group are ethyl acrylate, ethyl methacrylate, n-propyl acrylate, n-propyl methacrylate, isopropyl acrylate, isopropyl methacrylate, n-butyl acrylate, n-butyl methacrylate, isobutyl methacrylate, tert-butyl acrylate, tert-butyl methacrylate and isobutyl acrylate. Preferably used monomers of this group are n-butyl acrylate, isobutyl acrylate and tert-butyl acrylate. The monomers of group (b) are present in an amount of, for example, from 1 to 49% by weight, preferably from 15 to 25% by weight, in the reaction mixture comprising the components (a), (b), (c), (d) and (e).

C₅-C₂₂-Alkyl acrylates and/or C₅-C₂₂-alkyl methacrylates are used as monomers of group (c). These esters are derived from monohydric C₅- to C₂₂-alcohols. They can be used either alone or as a mixture with one another in the polymerization. Examples of monomers of group (c) are n-pentyl acrylate, n-pentyl methacrylate, neopentyl acrylate, neopentyl methacrylate, cyclohexyl acrylate, cyclohexyl methacrylate, 2-hexyl acrylate, 2-hexyl methacrylate, 2-ethylhexyl acrylate, 2-ethylhexyl methacrylate, n-octyl acrylate, n-octyl methacrylate, isooctyl acrylate, isooctyl methacrylate, n-decyl acrylate, n-decyl methacrylate, dodecyl acrylate, dodecyl methacrylate, palmityl acrylate, palmityl methacrylate, stearyl acrylate, stearyl methacrylate, behenyl acrylate and behenyl methacrylate. Preferably used monomers of group (c) are cyclohexyl acrylate, 2-ethylhexyl acrylate and 2-ethylhexyl methacrylate. The monomers of group (c) are present in an amount of, for example, from 1 to 49% by weight, preferably from 15 to 25% by weight, in the reaction mixture comprising the components (a), (b), (c), (d) and (e).

In order to modify the polymers, the polymerization can, if appropriate, be carried out in the presence of at least one further monomer (d). Suitable monomers (d) are in principle all monomers which differ from the monomers (a), (b) and (c). Examples of such monomers are vinyl acetate, vinyl propionate, hydroxyethyl acrylate, hydroxyethyl methacrylate, N-vinylformamide, acrylamide, methacrylamide, N-vinylpyrrolidone, N-vinylimidazole, N-vinylcaprolactam, acrylic acid, methacrylic acid, acrylamidomethylpropanesulfonic acid, styrenesulfonic acid, vinylsulfonic acid and salts of the monomers comprising acid groups. The acidic monomers can be used in partly or completely neutralized form. For example, sodium hydroxide solution, potassium hydroxide solution, sodium carbonate, sodium bicarbonate, calcium hydroxide and ammonia are used as neutralizing agents.

Further examples of monomers (d) are dialkylaminoalkyl(meth)acrylates and dialkylaminoalkyl(meth)acrylamides, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, dimethylaminoethylacrylamide, dimethylaminoethylmethacrylamide, dimethylaminopropylacrylamide and dimethylaminopropylmethacrylamide. The basic monomers can be used in the form of the free bases, as salts with organic acids or mineral acids or in quaternized form in the polymerization. The monomers of group (d) are present in an amount of, for example, from 0 to 10% by weight in the reaction mixture comprising the components (a), (b), (c), (d) and (e). If they are used for modifying the polymers, the preferably used amounts are from 1 to 8% by weight, based on the reaction mixture comprising the components (a), (b), (c), (d) and (e).

The polymerization of the monomers is effected in the presence of a degraded starch which has a molar mass M_{w} of from 1000 to 65 000. The average molecular weights M_{w} of the degraded starches can readily be determined by methods known to the person skilled in the art, for example by means of gel permeation chromatography using a multi-angle scattered light detector.

Such a starch can be obtained starting from all starch varieties, for example from starch from potatoes, corn, wheat, rice, tapioca, sorgum or waxy starches which have an amylopectin content of >80, preferably >95, % by weight, such as waxy corn starch or waxy potato starch. The starches may have been anionically and/or cationically modified, esterified, etherified and/or crosslinked. Anionic or cationized starches are preferred.

If the molecular weight M_{w}, of the starches is not already in the range from 1000 to 65 000, the molecular weight is decreased before the beginning of the polymerization or in a separate step. A procedure in which starch is enzymatically and/or oxidatively degraded before the beginning of the polymerization is preferred. The molar mass M_{w}, of the degraded starch is preferably in the range from 2500 to 35 000.

The use of cationized starches is particularly preferred. Cationized starches are known. They are prepared, for example, by reacting natural starch with at least one quaternizing agent, such as 2,3-epoxypropyltrimethylammonium chloride. The cationized starches comprise quaternary ammonium groups.

The proportion of cationic or anionic groups in the substituted starch is specified with the aid of a degree of substitution (DS). It is, for example, from 0.005 to 1.0, preferably from 0.01 to 0.4.

All starches may be used. Customary cationized starches are prepared, for example, by reacting natural starches, such as potato, wheat, corn, rice or tapioca starch, with at least one quaternizing agent. The degradation of the starches is preferably effected before the polymerization of the monomers but can also be carried out during the polymerization of the monomers. It can be carried out oxidatively, thermally, acidolytically or enzymatically. The starch degradation is preferably effected enzymatically and/or oxidatively directly before the beginning of the emulsion polymerization in the apparatus in which the polymerization is to be carried out or in a separate step. It is possible to use a single degraded starch or mixtures of two or more degraded starches in the polymerization. The starch is present in an amount of, for example, from 15 to 40% by weight, preferably from 25 to 35% by weight, in the reaction mixture comprising the components (a), (b), (c), (d) and (e).

The finely divided, starch-containing polymer dispersions according to the invention are obtainable by carrying out the polymerization in the presence of at least 0.01% by weight, based on the monomers used, of at least one polymerization regulator. In principle, all known regulators which reduce the molecular weight of the polymers forming may be used. Preferably used regulators are, however, organic compounds which comprise sulfur in bound form, for example mercaptans, di- and polysulfides, esters and sulfides of thio- and dithiocarboxylic acids and enol sulfides. Halogen compounds, aldehydes, ketones, formic acid, enol ethers, enamines, hydroxylamine, halogenated hydrocarbons, alcohols, ethylbenzene and xylene are also suitable as regulators.

Examples of regulators based on organic compounds which comprise sulfur in bound form are mercaptoethanol, mercaptopropanol, mercaptobutanol, thioglycolic acid, thioacetic acid, thiopropionic acid, thioethanolamine, sodium dimethyldithiocarbamate, cysteine, ethyl thioglycolate, trimethylolpropane trithioglycolate, pentaerythrityl tetra(mercaptopropionate), pentaerythrityl tetrathioglycolate, trimethylolpropane tri(mercaptoacetate), butyl methylenebisthioglycolate, thioglycerol, glyceryl monothioglycolate, n-octadecyl mercaptan, n-dodecyl mercaptan, tert-dodecyl mercaptan, butyl mercaptan, thiophenol, mercaptotrimethoxysilane and acetylcysteine.

Other suitable regulators are halogen compounds, such as trichloromethane, tetrachloromethane and bromotrichloromethane, aldehydes, such as acetaldehyde, propionaldehyde, crotonaldehyde and butyraldehyde, alcohols, such as n-propanol and isopropanol and buten-3-ol and allyl alcohol. Further suitable regulators are vitamin A acetate, vitamin A palmitate, geranial, neral, geraniol, geranyl acetate, limonene, linalyl acetate, terpinolene, γ-terpinene, α-terpinene, R(−)-α-phellandrene, terpineol, resorcinol, hydroquinone, pyrocatechol, phloroglucine and diphenylethylene. Further examples of regulators based on terpinolene and unsaturated alicyclic hydrocarbons are to be found, for example, in Winnacker-Küchler, Chemische Technologie, Volume 6, pages 374 to 381, Carl Hanser Verlag, Munich, Vienna, 1982.

The regulators are used in the polymerization in an amount of at least 0.01% by weight, based on the monomers. The amounts depend substantially on the efficiency of the regulator or regulators used in each case. They are, for example, in the range from 0.01 to 10% by weight, preferably from 0.05 to 5.0% by weight, based on the monomers (a), (b), (c) and (d). The polymerization is preferably carried out in the presence of tert-dodecyl mercaptan as a regulator.

According to the invention, a redox initiator is used for initiating the polymerization. Said initiator preferably comprises graft-linking, water-soluble redox systems, for example comprising hydrogen peroxide and a heavy metal salt or comprising hydrogen peroxide and sulfur dioxide or comprising hydrogen peroxide and sodium metabisulfite. Further suitable redox systems are combinations of tert-butyl hydroperoxide/sulfur dioxide, sodium or potassium persulfate/sodium bisulfite, ammonium persulfate/sodium bisulfite or ammonium persulfate/iron(II) sulfate. Hydrogen peroxide in combination with a heavy metal salt, such as iron(II) sulfate, is preferably used. Frequently, the redox system additionally comprises a further reducing agent, such as ascorbic acid, sodium formaldehyde sulfoxylate, sodium disulfite or sodium dithionite. Since the polymerization of the monomers is effected in the presence of starch and since starch likewise acts as a reducing agent, the concomitant use of further reducing agents is generally dispensed with. The redox initiators are used, for example, in an amount of from 0.05 to 10% by weight, preferably from 0.1 to 5% by weight, based on the monomers.

The emulsion polymerization of the monomers (a) to (d) is effected in an aqueous medium in the presence of a starch (e) having a molar mass M_{w} of from 1000 to 65 000. The monomers can be polymerized by the emulsion polymerization method, both in the feed procedure and in the batch procedure. Preferably, an aqueous solution of a degraded cationized starch and a heavy metal salt is initially taken and the monomers are added continuously or batchwise, either separately or as a mixture and separately therefrom, to that part of the redox initiator which has oxidizing activity, preferably hydrogen peroxide. A gradient procedure which is disclosed in WO 02/14393 can also be used for the preparation of the starch-containing polymer dispersions.

The addition can be effected uniformly or nonuniformly, i.e. with changing metering rate, over the metering period.

The polymerization is usually carried out in the absence of oxygen, preferably in an inert gas atmosphere, for example under nitrogen. During the polymerization, thorough mixing of the components should be ensured. Thus, the reaction mixture is preferably stirred for the entire duration of the polymerization and of any subsequent postpolymerization.

The polymerization is usually carried out at temperatures of from 30 to 110° C., preferably from 50 to 100° C. The use of a pressure reactor for carrying out a continuous polymerization in a stirred kettle cascade or a flow tube is also possible.

In order to increase the dispersing effect, conventional ionic, nonionic or amphoteric emulsifiers can be added to the polymerization batch. Customary emulsifiers are only used if appropriate. The amounts used are from 0 to 3% by weight and are preferably in the range from 0.02 to 2% by weight, based on the sum of the monomers (a) to (d) used. Conventional emulsifiers are described in detail in the literature, cf. for example M. Ash, I. Ash, Handbook of Industrial Surfactants, Third Edition, Synapse Information Resources Inc. Examples of conventional emulsifiers are the reaction products of long-chain monohydric alcohols (C₁₀- to C₂₂-alkanols) with from 4 to 50 mol of ethylene oxide and/or propylene oxide per mole of alcohol or ethoxylated phenols or alkoxylated alcohols esterified with sulfuric acid which are generally used in a form neutralized with alkali. Further conventional emulsifiers are, for example, sodium alkanesulfonates, sodium alkylsulfates, sodium dodecylbenzenesulfonate, sulfosuccinic esters, quaternary alkylammonium salts, alkylbenzylammonium salts, such as dimethyl-C₁₂- to C₁₈-alkylbenzylammonium chlorides, primary, secondary and tertiary fatty amine salts, quaternary amidoamine compounds, alkylpyridinium salts, alkylimidazolinium salts and alkyloxazolinium salts.

During the emulsion polymerization, either the monomers can be metered directly into the initially taken mixture or they can be added in the form of an aqueous emulsion or miniemulsion to the polymerization batch. For this purpose, the monomers are emulsified in water using the abovementioned conventional emulsifiers.

The polymerization is carried out at a pH of from 2 to 9, preferably in the weakly acidic range at a pH of from 3 to 5.5. The pH can be adjusted to the desired value before or during the polymerization using conventional acids, such as hydrochloric acid, sulfuric acid or acetic acid, or using bases, such as sodium hydroxide solution, potassium hydroxide solution, ammonia, ammonium carbonate, etc. The dispersion is preferably adjusted to a pH of from 5 to 7 with sodium hydroxide solution, potassium hydroxide solution or ammonia after the end of the polymerization.

In order to remove the remaining monomers from the starch-containing polymer dispersion as substantially as possible, a postpolymerization is expediently carried out. For this purpose, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water are preferably used, for example conventional organic peroxides, such as dibenzoyl peroxide, di-tert-butyl peroxide, tert-butyl hydroperoxide, cumyl hydroperoxide or biscyclohexyl peroxydicarbonate.

For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. tert-Butyl hydroperoxide is preferably used for the postpolymerization. The postpolymerization is carried out, for example, in a temperature range from 35 to 100° C., in general from 45 to 95° C.

After the end of the polymerization, a complexing agent for heavy metal ions can be added to the polymer dispersion in an amount such that all heavy metal ions are bound in complexed form. The starch-containing polymer dispersions comprise dispersed particles having a mean particle size of from 20 to 500 nm, preferably from 50 to 250 nm. The mean particle size can be determined by means of methods known to the person skilled in the art, such as, for example, laser correlation spectroscopy, ultracentrifuging or HDF (hydrodynamic fractionation). A further measure of the particle size of the dispersed polymer particles is the LT value. In order to determine the LT value (light transmittance), the polymer dispersion being investigated in each case is measured in 0.1% strength by weight aqueous dilution in a cell of edge length 2.5 cm using light of 600 nm wavelength and compared with the corresponding transmittance of water under the same measuring conditions. The transmittance of water is specified as 100%. The more finely divided the dispersion, the higher is the LT value which is measured by the method described above. From the measured values, the mean particle size can be calculated, cf. B. Verner, M. Bárta, B. Sedlácek, Tables of Scattering Functions for Spherical Particles, Prague, 1976, Edice Marco, Rada D-DATA, SVAZEK D-1.

The solids content of the starch-containing polymer dispersion is, for example, from 5 to 50% by weight and is preferably in the range from 15 to 40% by weight.

The starch-containing polymer dispersions described above are used as sizes for paper, board and cardboard. They can be used both as surface size and as engine size in the respective conventional amounts. The use as surface size is preferred. The dispersions according to the invention can be processed by all methods suitable for surface sizing. The polymer dispersions can be applied, for example, by means of a size press, a film press or a gate-roll applicator to the surface of the paper to be sized. For the application, the dispersion is usually added to the size press liquor in an amount of from 0.05 to 3% by weight, based on solid substance and depends on the desired degree of sizing of the papers to be finished. Furthermore, the size press liquor may comprise further substances, such as, for example, starch, pigments, optical brighteners, biocides, strength agents for paper, fixing agents, antifoams, retention aids and/or drainage aids. The amounts of polymer which are applied to the surface of paper products are, for example, from 0.005 to 1.0 g/m², preferably from 0.01 to 0.5 g/m². Compared with the known sizes, the sizes according to the invention have the advantage that they give a better sizing effect even with small applied amounts on alum-containing and on polyaluminum chloride-containing (PAC) papers.

Unless otherwise evident from the context, the stated percentages in the examples are always percent by weight. The particle sizes were determined by means of a high performance particle sizer (HPPS) from Malvern using an He—Ne laser (633 nm) at a scattering angle of 173°.

The LT values were determined in 0.1% strength aqueous solution of the dispersion to be determined, using a DR/2010 from Hach at a wavelength of 600 nm.

### EXAMPLE 1

128.3 g of a cationized corn starch (DS value of 0.045) were initially taken in a 2 l flask having a plane ground joint and having a stirrer and means for internal temperature measurement. 485.9 g of demineralized water, 14 g of an α-amylase (1%) and 1.4 g of 25% strength calcium acetate hydrate were added while stirring. The mixture was then heated to 85° C. and stirred for 30 min. 7.0 g of glacial acetic acid and 1.4 g of 10% strength iron(II) sulfate heptahydrate were then added. Thereafter, 6.24 g of an 18% strength hydrogen peroxide solution were metered in over a period of 30 min. Thereafter, a monomer feed consisting of 49.3 g of demineralized water, 0.26 g of a mixture of the sodium salt of alkanesulfonates having an average chain length of C15 (40% strength), 3.5 g of tert-dodecyl mercaptan, 122.5 g of styrene, 61.25 g of 2-ethylhexyl acrylate and 61.25 g of tert-butyl acrylate were started and were metered in over 120 min. At the same time, the feeding of 56.2 g of 18% strength hydrogen peroxide solution over a period of 150 minutes was started. The mixture was postpolymerized for 30 min and then cooled to 50° C. Thereafter, 17.6 g of 10% strength tert-butyl hydroperoxide were added in the course of 60 min and 1.1 g of a 40% strength aqueous solution of the tetrasodium salt of ethylenediaminetetra acetic acid were then added and the reaction mixture was cooled to 30° C.

A finely divided polymer dispersion having a solids content of 37.7% and an LT value (0.1%) of 55% was obtained. The mean particle size was 113 nm.

### EXAMPLE 2

82.5 g of a cationized potato starch (DS value=0.1) were initially taken in a 2 l flask having a plane ground joint and having a stirrer and means for internal temperature measurement. 460.5 g of demineralized water, 10 g of α-amylase (1% strength) and 1.1 g of 25% strength calcium acetate hydrate were added while stirring. The mixture was heated to 85° C. and stirred for 30 min at this temperature. Thereafter, 10.0 g of glacial acetic acid and 2.8 g of 10% strength iron(II) sulfate heptahydrate were added and then 4.3 g of an 18% strength hydrogen peroxide solution. A monomer feed consisting of 135.0 g of demineralized water, 0.21 g of a mixture of the sodium salt of alkanesulfonates having an average chain length of C15 (40% strength), 2.5 g of tert-dodecyl mercaptan, 92.0 g of styrene, 46 g of 2-ethylhexyl acrylate and 46 g of tert-butyl acrylate was then started. The duration of the monomer feed was 90 min. At the same time, a feed of 49.6 g of 18% strength hydrogen peroxide solution over a period of 120 min was started. The mixture was postpolymerized for 30 min and then cooled to 50° C. Thereafter, 2.4 g of 10% strength tert-butyl hydroperoxide were added to the postpolymerization and the reaction mixture was stirred for 30 min at 50° C. and then cooled to 30° C.

A finely divided polymer dispersion having a solids content of 25.4% and an LT value (0.1%) of 72% was obtained. The mean particle size was 95 nm.

### EXAMPLE 3

59.24 g of a cationized corn starch (DS value=0.04) were initially taken in a 2 l flask having a plane ground joint and having a stirrer and means for internal temperature measurement. 244.7 g of demineralized water, 8 g of an α-amylase (1% strength) and 0.9 g of 25% strength calcium acetate hydrate were added while stirring. The mixture was heated to 85° C. and stirred for 30 min at this temperature. Thereafter, 8.0 g of glacial acetic acid and 2.2 g of 10% strength iron(II) sulfate heptahydrate were added and then 3.5 g of an 18% strength hydrogen peroxide solution. A monomer feed consisting of 107.8 g of demineralized water, 0.17 g of a mixture of the sodium salt of alkanesulfonates having an average chain length of C15 (40% strength), 2.0 g of tert-dodecyl mercaptan, 73.5 g of styrene, 36.7 g of 2-ethylhexyl acrylate and 36.7 g of tert-butyl acrylate was then started. The duration of the feed was 90 min. At the same time, a feed of 39.6 g of 18% strength hydrogen peroxide solution over a period of 120 min was started. The mixture was postpolymerized for 30 min and then cooled to 50° C. Thereafter, 2.4 g of 10% strength tert-butyl hydroperoxide were added to the postpolymerization and the reaction mixture was stirred for 30 min at 50° C. and then cooled to 30° C. The dispersion was then rendered neutral by adding 20.7 g of 25% strength NaOH.

A finely divided polymer dispersion having a solids content of 27.2% and an LT value (0.1%) of 65% was obtained. The mean particle size was 74 nm.

### EXAMPLE 4

60.4 g of a cationized starch (DS value=0.045) were initially taken in a 2 l flask having a plane ground joint and having a stirrer and means for internal temperature measurement. 243.6 g of demineralized water, 8 g of an α-amylase (1% strength) and 0.9 g of 25% strength calcium acetate hydrate were added while stirring. The mixture was heated to 85° C. and stirred for 30 min at this temperature. Thereafter, 8.0 g of glacial acetic acid and 2.2 g of 10% strength iron(II) sulfate heptahydrate were added and then 3.5 g of an 18% strength hydrogen peroxide solution were added. A monomer feed consisting of 107.8 g of demineralized water, 0.17 g of a mixture of the sodium salt of alkanesulfonates having an average chain length of C15 (40% strength), 2.0 g of tert-dodecyl mercaptan, 73.4 g of styrene, 36.7 g of 2-ethylhexyl acrylate and 36.7 g of tert-butyl acrylate was then started. The duration of the feed was 90 min. At the same time, a feed of 39.6 g of 18% strength hydrogen peroxide solution over a period of 120 min was started. The mixture was postpolymerized for 30 min and then cooled to 50° C. Thereafter, 1.9 g of 10% strength tert-butyl hydroperoxide were added and the mixture was stirred for a further 30 min and then cooled to 30° C. 20.8 g of 25% strength NaOH were then added, with the result that the dispersion was rendered neutral. A finely divided polymer dispersion having a solids content of 26.7% and an LT value (0.1%) of 66% was obtained. The mean particle size was 87 nm.

### EXAMPLE 5

79.55 g of an amonic starch (DS value=0.044) were initially taken in a 2 l flask having a plane ground joint and having a stirrer and means for internal temperature measurement. 430 g of demineralized water, 2.30 g of an α-amylase (1% strength) and 1.02 g of 25% strength calcium acetate hydrate were added while stirring. The mixture was heated to 85° C. and stirred for 30 min at this temperature. Thereafter, 9.22 g of glacial acetic acid and 2.60 g of 10% strength iron(II) sulfate heptahydrate were added and then 4.9 g of an 18% strength hydrogen peroxide solution were added. A monomer feed consisting of 124.17 g of demineralized water, 0.20 g of a mixture of the sodium salt of alkanesulfonates having an average chain length of C15 (40% strength), 2.3 g of tert-dodecyl mercaptan, 84.64 g of styrene, 42.32 g of ethylhexyl acrylate and 42.32 g of tert-butyl acrylate was then started. The duration of the feed was 90 min. At the same time, a feed of 39.6 g of 18% strength hydrogen peroxide solution over a period of 120 min was started. The mixture was postpolymerized for 30 min and then cooled to 50° C. Thereafter, 2.19 g of 10% strength tert-butyl hydroperoxide were added and the mixture was stirred for a further 30 min and then cooled to 30° C. 28.94 g of 25% strength NaOH and 100 ml of water were then added, with the result that the dispersion was rendered neutral. A finely divided polymer dispersion having a solids content of 25.47% and an LT value (0.1%) of 83% was obtained. The mean particle size was 98 nm.

### COMPARATIVE EXAMPLE 1

### Corresponding to Example 2 of EP-A-0307816

31.1 g of an oxidatively degraded potato starch (Amylofax 15 from Avebe) in 199.5 g of demineralized water were then taken, under a nitrogen atmosphere and with stirring, in a polymerization vessel which was equipped with a stirrer, reflux condenser, jacket heating and metering apparatus. The starch was dissolved while stirring by heating to 85° C. At this temperature, 5.6 g of glacial acetic acid, 0.05 g of iron(II) sulfate (FeSO₄.7H₂O) and 1.2 g of a 30% strength by weight hydrogen peroxide solution were added in succession. After 20 minutes, a further 1.2 g of a 30% strength by weight hydrogen peroxide solution were added. A mixture consisting of 66 g of n-butyl acrylate, 58.5 g of styrene, 0.07 g of sodium laurylsulfate and 43.5 g of demineralized water was then metered in the course of 2 h. At the same time, the initiator feed of 21 g of a 5.5% strength by weight hydrogen peroxide solution began, which feed was likewise metered over 2 h at constant metering rate. After the end of the feeds, polymerization was continued for a further hour at 85° C. After filtration (125 μm), a dispersion having a solids content of 33.9%, an LT value (0.01%) of 86 and a particle size of 110 nm (laser correlation spectroscopy) was obtained.

The polymer dispersions obtained according to the examples and comparative example 1 were tested as surface sizes for paper. The test paper and the test method are described below. The results obtained in each case are summarized in table 1.

### Test Methods:

The determination of the degree of sizing was effected by the Cobb60 method according to DIN EN 20 535. The HST value was determined by the Hercules Sizing Test according to Tappi standard T 530. The ink flotation test was carried out according to DIN 53 126 using a blue paper test ink. The toner adhesion was determined according to EN 12883 at a constant speed on an IGT tester. The dynamic contact angle was determined according to ASTM D5725 by means of Fibro DAT 1100.

### Description of the DAT Test (Dynamic Contact Angle and Absorption Test):

Addition of a drop of test liquid (1:10 isopropanol/water) to the paper surface and measurement of the change of the contact angle as a function of time. This is observed using a video camera. The contact angle is the internal angle between the drop tangent and the paper surface. The higher the value at the respective time, the better is the sizing effect. (Time steps: 1-3-5 sec)

### Testing of Performance Characteristics as Surface Size:

An anionically modified potato starch was brought into solution by heating to 95° C. for 30 minutes. Thereafter, the polymer dispersion to be tested was added to the starch solution and the latter was diluted with water so that a starch concentration of 8% was present in the prepared mixture. The mixture of starch solution and polymer dispersion was then applied at a temperature of 25° C. by means of a size press to a paper having a basis weight of 64 g/m², which has been lightly presized in the pulp with AKD (alkyldiketene) and alum. The absorption of the preparation was in the range of 20-25%. Thereafter, the papers thus treated were dried by contact drying at 90° C., conditioned or 24 h at 50% relative humidity and then subjected to the tests.

The test paper used was an alum-containing paper which had been lightly presized and had the following composition:

60% of DIP (de-inked pulp)
25.5% of bleached birch sulfate
1.0% of aluminum sulfate
12.5% of Precarb 100 (filler)
0.5% of Blancophor ® P (optical brightener)
1.3% of Basoplast ® 2009 LC (size)
0.03% of Polymin ® KE 78 (retention aid)

The amounts of polymer dispersion in the size press liquor were 0.5 g/l (based on solid of the polymer dispersion).

TABLE 1

| | DAT (°) | DAT (°) | Cobb60 | Toner adhesion |
|---|---|---|---|---|
| | after 1 sec | after 3 sec | (g/m²) | (% ink density) |
| Example 1 | 55 | 45 | 56 | 72 |
| Example 2 | 66 | 59 | 45 | 78 |
| Example 3 | 61 | 54 | 54 | 75 |
| Example 4 | 60 | 49 | 57 | 77 |
| Example 5 | 68 | 55 | 45 | 71 |
| Comparative ex. 1 | 47 | 32 | 76 | 67 |

1. A finely divided, starch-containing polymer dispersion which is obtainable by free radical emulsion copolymerization of ethylenically unsaturated monomers in the presence of at least one redox initiator and starch, wherein
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer
are used as ethylenically unsaturated monomers and
(e) from 15 to 40% by weight of at least one degradable starch which has a molar mass M_{w}, of from 1000 to 65 000
are used as starch,
the sum (a)+(b)+(c)+(d)+(e) being 100% and being based on the total solids content, and wherein the polymerization is carried out in the presence of at least 0.01% by weight, based on the monomers used, of at least one polymerization regulator.

2. The finely divided, starch-containing polymer dispersion according to claim 1, wherein
(a) from 30 to 40% by weight of at least one optionally substituted styrene, methyl methacrylate, acrylonitrile and/or methacrylonitrile,
(b) from 15 to 25% by weight of at least one C₁-C₄-alkyl acrylate and/or one C₂-C₄-alkyl methacrylate,
(c) from 15 to 25% by weight of at least one C₅-C₁₈-alkyl acrylate and/or one C₅-C₁₈-alkyl methacrylate and
(d) from 0 to 10% by weight of at least one other ethylenically unsaturated copolymerizable monomer
are used as ethylenically unsaturated monomers and
(e) from 25 to 35% by weight of at least one degraded starch which has a molar mass M_{w}, of from 2500 to 35 000
are used as starch,
the sum (a)+(b)+(c)+(d)+(e) being 100% and being based on the total solids content.

3. The finely divided, starch-containing polymer dispersion according to claim 1, wherein the regulator used is at least one organic compound which comprises sulfur in bound form.

4. The finely divided, starch-containing polymer dispersion according to claim 1, wherein
(a) at least one monomer from the group consisting of styrene, methyl methacrylate, acrylonitrile and/or methacrylonitrile,
(b) n-butyl acrylate, isobutyl acrylate, sec-butyl acrylate and/or tert-butyl acrylate,
(c) 2-ethylhexyl acrylate and/or 2-ethylhexyl methacrylate and
(d) at least one monomer from the group consisting of vinyl acetate, vinyl propionate, hydroxyethyl acrylate, hydroxyethyl methacrylate, N-vinylformamide, acrylamide, methacrylamide, N-vinylpyrrolidone, N-vinylcaprolactam, N-vinylimidazole, acrylic acid, methacrylic acid, acrylamidomethylpropanesulfonic acid, vinylsulfonic acid, styrenesulfonic acid and salts of the monomers comprising acid groups
are used as ethylenically unsaturated monomers and tert-dodecyl mercaptan is used as the regulator.

5. The finely divided, starch-containing polymer dispersion according to claim 1, wherein the regulators are used in an amount of from 0.01 to 10% by weight, based on the monomers.

6. The finely divided, starch-containing polymer dispersion according to claim 1, wherein the regulators are used in an amount of from 0.05 to 5.0% by weight, based on the monomers.

7. A process for the preparation of finely divided, starch-containing polymer dispersions according to claim 1, wherein
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer
and
(e) from 15 to 40% by weight of at least one degraded starch which has a molar mass M_{w} of from 1000 to 6, the sum (a)+(b)+(c)+(d)+(e) being 100% and being based on the total solids content, are polymerized in the presence of a redox initiator and of at least 0.01% by weight, based on the monomers used, of at least one polymerization regulator.

8. The process according to claim 7, wherein the polymerization is carried out in the presence of, as the regulator, from 0.05 to 5.0% by weight of at least one organic compound which comprises sulfur in bound form.

9. The process according to claim 7, wherein the polymerization is carried out in the presence of tert-dodecyl mercaptan as the regulator.

10. The process according to any of claim 7, wherein an initiator from the group consisting of hydrogen peroxide, peroxides, hydroperoxides and/or azo initiators is added to the polymer dispersion after the end of the main polymerization, and a postpolymerization is carried out.

11. The process according to claim 10, wherein tert-butyl hydroperoxide is added to the polymer dispersion for the postpolymerization.

12. The process according to claim 7, wherein the starch used is a degraded cationized starch.

13. The process according to claim 7, wherein the starch used is a degraded anionic starch.

14. The process according to claim 7, wherein the cationized or anionic starch is enzymatically and/or oxidatively degraded before the beginning of the polymerization.

15. The process according to claim 1, wherein, after the end of the polymerization, a complexing agent for heavy metal ions is added to the polymer dispersion in an amount sufficient to bond all heavy metal ions with complex formation.

16. The method of using the starch-containing polymer dispersions according to claim 1 as sizes for paper, board and cardboard.
